(19) United States
(12) Patent Application Publication
(10) Pub. No.: US 2015/0091267 A1
(43) Pub. Date: Apr. 2, 2015

(54) BABY CAR SEAT INSTA-STROLLER

(71) Applicant: Rhett Conner, Longview, WA (US)

(72) Inventor: Rhett Conner, Longview, WA (US)

(21) Appl. No.: 14/504,131

(22) Filed: Oct. 1, 2014

Related U.S. Application Data
(60) Provisional application No. 61/885,439, filed on Oct. 1, 2013.
(60) Provisional application No. 61/894,330, filed on Oct. 22, 2013.

(51) Int. Cl. B62B 5/00; B62B 1/06; B62B 1/04

(52) U.S. Cl. CPC B62B 5/0089; B62B 1/047; B62B 1/06
USPC 280/47.315

(57) ABSTRACT

A car seat mobility assembly configured to couple to an infant car seat. The car seat mobility assembly has a telescoping handle coupled to one or more wheel brackets each a wheel coupled thereto. The wheel bracket is configured to couple to the car seat. The car seat mobility assembly has one or more handle brackets coupled to the handle and configured to couple to the car seat. A user can push the car seat along flat or nearly flat ground while remaining erect with normal posture and with a normal walking gait. The user pushes down on the handle to rotate the car seat about the wheels, lifting the forward part of the car seat off the ground, and then pushes the handle in a forward direction to move the car seat forward.

### CROSS-REFERENCE TO RELATED APPLICATION

The present application claims the benefit of, and priority to, U.S. Provisional Application No. 61/885,439 filed on 1 Oct. 2013; and U.S. Provisional Application No. 61/894,330 filed on 22 Oct. 2013 both incorporated herein by reference.

### FIELD OF THE INVENTION

The present invention relates to portable car seats for young children and infants.

### BACKGROUND

Car seats for infants and young children are required in all 50 states and many foreign jurisdictions as well. Many car seats are designed to be removed from the car with an infant inside and carried by a user, usually an adult, but occasionally an older child. Usually a handle is provided for this purpose. Carrying an infant in this way is convenient for only short distances. Car seats generally average around 8 to 9 lbs., with some as low as 5.5 lbs. and others as heavy as 10 lbs. The combination of infant and car seat can be rather heavy—over 25 lbs. for older infants. Carrying an infant in a car seat by the handle is awkward. The car seat is typically over a foot wide, with the handle and center of gravity over 6 inches away from the edge. The user cannot carry the car seat with their arm hanging naturally downwards from the shoulder, but will be forced to have their hand 6 inches or more to the outside of the shoulder. This puts a torque on the user that must be counter-acted by leaning in the opposite direction or applying a resisting force with the user's back and shoulder musculature. Even for large and strong adult users, this can be tiring very quickly and can injure their back and shoulders. The problem is worse for users that are small adults or older children.

One solution to this problem has been stroller-car seat combinations. In such combinations, the car seat can be detachably coupled to the stroller for pedestrian travel and detached again for securing in a vehicle for vehicular travel. However, this necessitates transporting of the stroller component during vehicular travel, taking up extra storage room in the vehicle, which may be in short supply.

What is needed is a car seat that can be pushed but without a separate stroller component.

### SUMMARY

A car seat mobility assembly configured to couple to an infant car seat is disclosed herein. The car seat mobility assembly has a telescoping handle coupled to one or more wheel brackets each a wheel coupled thereto. The wheel bracket is configured to couple to the car seat. The car seat mobility assembly has one or more handle brackets coupled to the handle and configured to couple to the car seat. A user can push the car seat along flat or nearly flat ground while remaining erect with normal posture and with a normal walking gait. The user pushes down on the handle to rotate the car seat about the wheels, lifting the forward part of the car seat off the ground, and then pushes the handle in a forward direction to move the car seat forward. The car seat can be steered by moving the handle laterally relative to the forward part of the car seat. Steering can be accomplished while simultaneously pushing the handle in the forward direction.

### BRIEF DESCRIPTION OF THE DRAWINGS

The accompanying drawings, which are incorporated into and constitute a part of this specification, illustrate one or more embodiments of the invention and, together with the detailed description, serve to explain the principles and implementations of the invention.

FIG. 1 is a side view of a car seat mobility assembly attached to a car seat.

FIG. 2 is a side view of the car seat mobility assembly of FIG. 1 attached to a car seat with the car seat turned over.

FIG. 3 is a front view of a user pushing a car seat with the car seat mobility assembly.

FIG. 4 is a front view of a user pulling a car seat with the car seat mobility assembly.

FIG. 5 is a rear view of a car seat with the car seat mobility assembly attached, partially inserted into a car seat base.

FIG. 6 is a rear view of a car seat with the car seat mobility assembly attached, fully inserted into a car seat base.

FIG. 7 shows a wheel cover for use with the car seat mobility assembly.

FIG. 8 a rear view of a car seat with the car seat mobility assembly attached and fully inserted into a car seat base with a wheel cover placed over the wheels of the car seat mobility assembly.

FIG. 9 a rear perspective view of a car seat with the car seat mobility assembly attached and fully inserted into a car seat base with a wheel cover placed over the wheels of the car seat mobility assembly.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

### EXEMPLARY EMBODIMENT

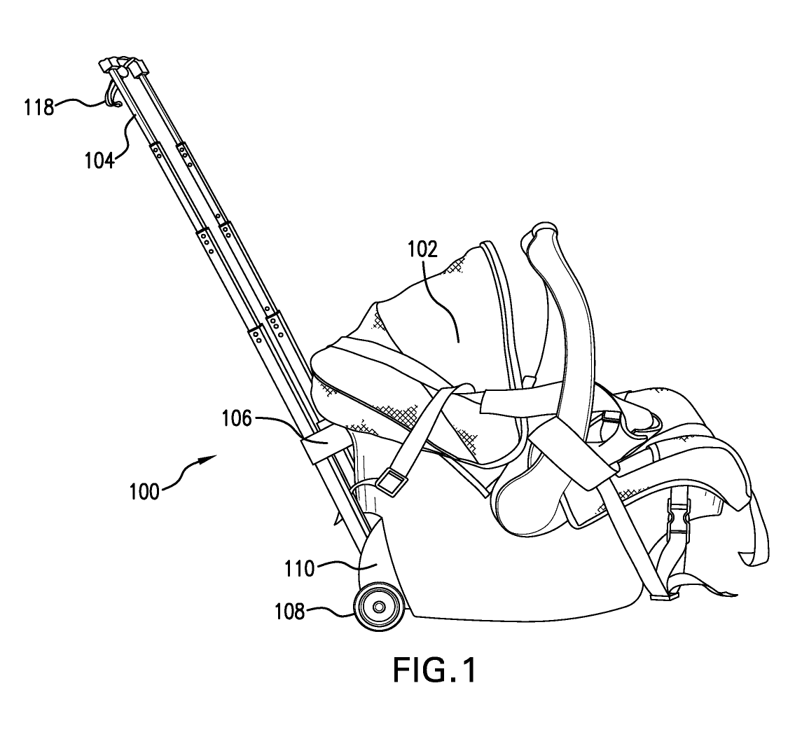

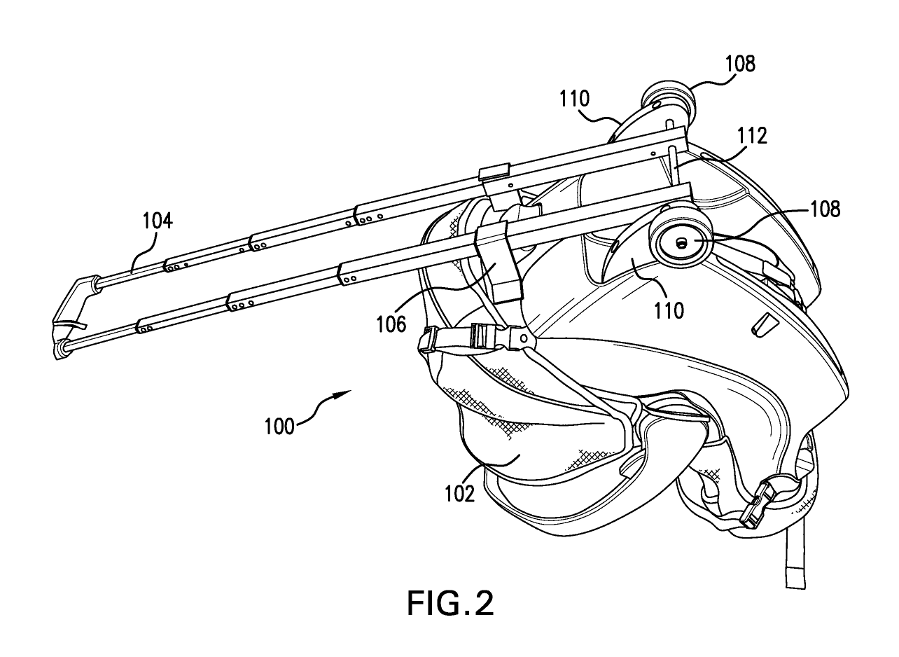

FIGS. 1 and 2 show a car seat mobility assembly 100 attached to a car seat 102. The car seat mobility assembly 100 has a handle 104 coupled to one or more wheel brackets 110. Each wheel bracket 110 has a wheel 108 coupled thereto. The wheel bracket 110 is configured to couple to the car seat 102. The car seat mobility assembly 100 has one or more handle brackets 106 coupled to the handle 104 and configured to couple to the car seat 102.

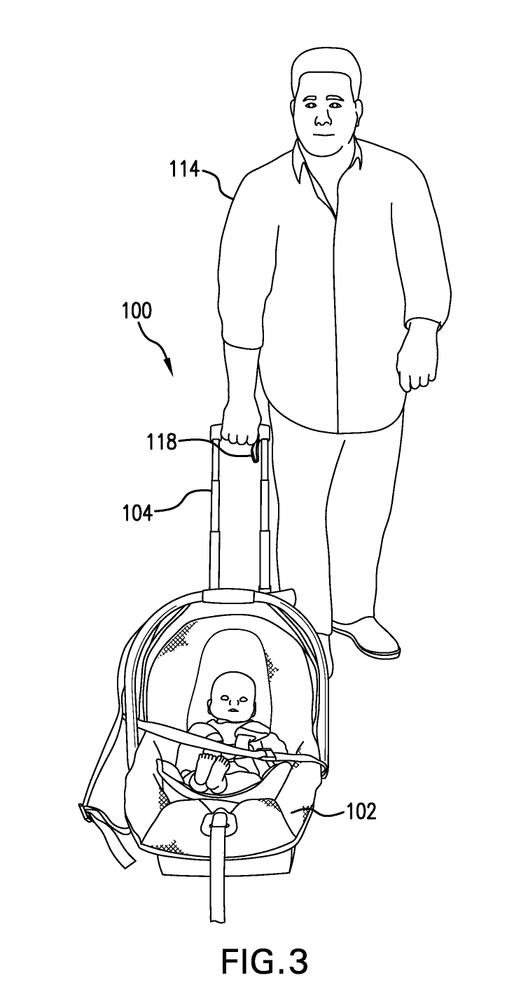

With the car seat mobility assembly 100 coupled to the car seat 102, a user can push the car seat 102 along flat or nearly flat ground while remaining erect with normal posture and with a normal walking gait, as shown in FIG. 3. The user pushes down on the handle 104 to rotate the car seat 102 about the wheels 108, lifting the forward part of the car seat 102 off the ground, and then pushes the handle 104 in a forward direction to move the car seat 102 forward. The car seat 102 can be steered by moving the handle 104 laterally relative to the forward part of the car seat 102. Steering can be accomplished while simultaneously pushing the handle 104 in the forward direction.

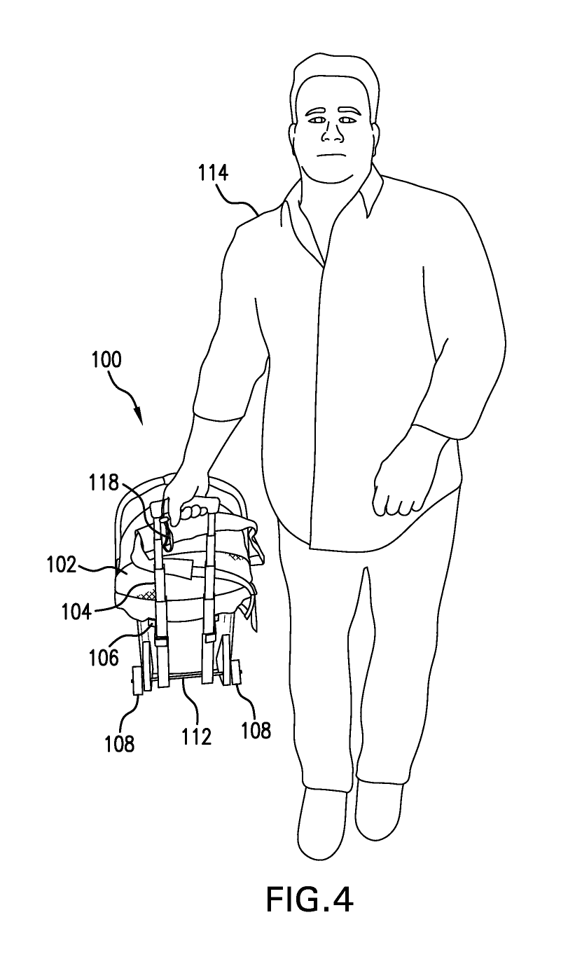

The user can also pull the car seat 102 with the car seat mobility assembly 100, as shown in FIG. 4. The user pulls the handle 104 forward, which will rotate the car seat 102 about the wheels 108, lifting the forward part of the car seat 102 (now facing opposite direction of travel) off the ground while also pulling the car seat 102 forward along the direction of travel.

In the exemplary embodiment, the handle 104 is configured to have an adjustable length with a telescoping mechanism. This will allow the handle 104 to be stowed compactly and out of the way when loading the car seat 102 into a vehicle, and extended out again when unloaded from the vehicle, ready for ambulatory travel. In other embodiments, the handle 104 may be folding, accruing many of the same advantages as the telescoping handle in the exemplary embodiment. In yet other embodiments, the handle 104 is of fixed length.

A run-away wrist strap 118 is attached to the handle 104 in the exemplary embodiment. The run-away wrist strap 118 allows the user to wrap his or her wrists in the run-away wrist strap 118 to provide a more secure connection between the user and the car seat mobility assembly 100 and car seat 102 combination. The run-away wrist strap 118 improves safety, allowing the user to maintain greater contact with the car seat mobility assembly 100 and car seat 102, minimizing the risk that the car seat 102 can escape the user.

In the exemplary embodiment, the wheel brackets 110 are coupled to the car seat 102 at the bottom of the car seat 102 on the head end. The wheel brackets 110 are attached to the car seat 102 with screws, but in other embodiments, other ways of attachment may be used, such as bolting or welding. In yet other embodiments, the wheel brackets 110 are integrally formed in a body of the car seat 102, mostly likely by the manufacturer of the car seat 102.

The car seat mobility assembly 100 has an axle 112 coupled to and penetrating each wheel bracket 110. The axle 112 can rotate freely relative to the wheel brackets 110. Each wheel 108 is coupled to an end of the axle 112.

In the exemplary embodiment, the handle brackets 106 are configured to couple to the car seat 102 with screws, but in other embodiments may be configured to couple in some other way, such as embedding in the car seat 102 material when the car seat 102 is made. In the exemplary embodiment, the handle brackets 106 are located as far above the bottom of the car seat 102 as practicable, so as to give the most leverage for using the handle 104 to rotate the car seat 102 about the wheels 108.

In alternative embodiments, the car seat mobility assembly 100 may configured to be removeably coupled to the car seat 102. In such embodiments, the handle bracket 106 and wheel bracket 110 may have clamping connectors that removeably clamp to portions of the car seat 102 or may have some other suitable mechanisms for removeably coupling the handle bracket 106 and wheel bracket 110 to the car seat 102. With the car seat mobility assembly 100 removeably attachable to the car seat 102, flexibility is maximized. The car seat mobility assembly 100 need not be carried if no need is anticipated for its use and may be left at home or in the car for use on other occasions. The car seat mobility assembly 100 is more likely to get dirty than the car seat 102, so being removable facilitates washing of the car seat mobility assembly 100 since it can be washed separately.

In some embodiments, the wheels 108 are reflective. This will make the car seat mobility assembly 100 visible at night, particularly in the headlights of car drivers and will draw attention to the car seat 102. In some embodiments, reflectors are coupled to the wheels 108 to make them reflective. In other embodiments, the wheels 108 are made of reflective material.

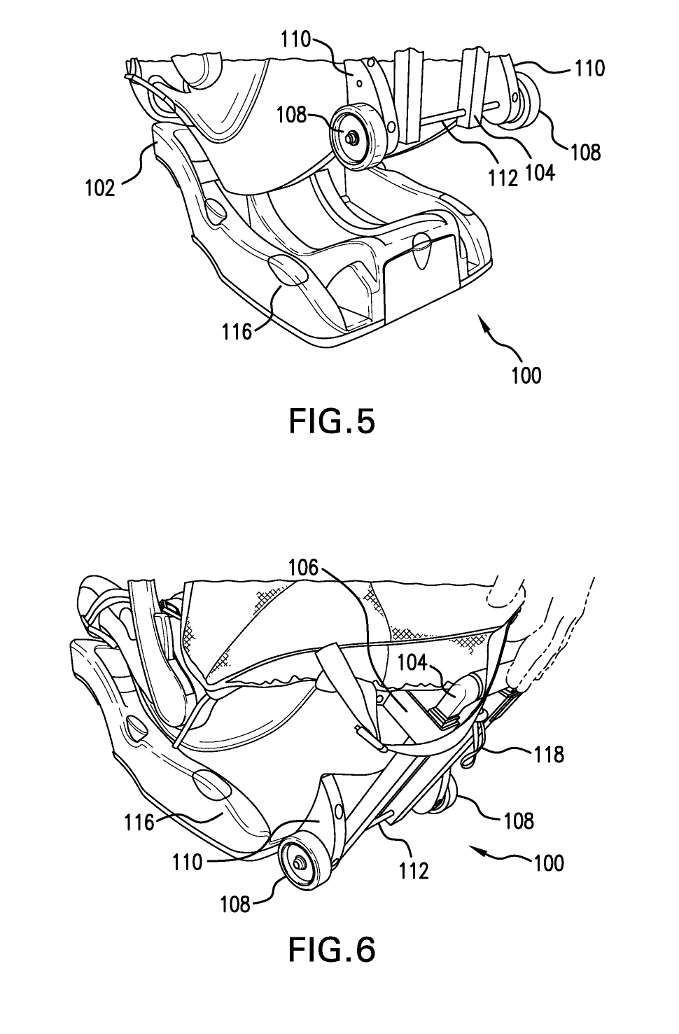

FIG. 5 is a rear view of the car seat 102 with the car seat mobility assembly 100 attached partially inserted into a car seat base 116. The car seat base 116 usually remains in a vehicle. The car seat 102 is designed to be detachable but securely couple to the car seat base 116. The wheel brackets 110 of the car seat mobility assembly 100 are configured to not interfere with the car seat base 116 when the car seat 102 is coupled to the car seat mobility assembly 100 and the car seat 102 is inserted into the car seat base 116. FIG. 6 show the car seat 102 with the car seat mobility assembly 100 attached and the car seat 102 fully inserted into a car seat base.

This car seat mobility assembly 100 invention enables a mode of baby travel by combining the modern car seat and the stroller to produce a car-seat that can become stroller if one chooses and provides the same societal change potential as when wheels and handle were added to the old static suitcase adding convenience, ease, and lowered stress on the musculoskeletal system thus increasing health.

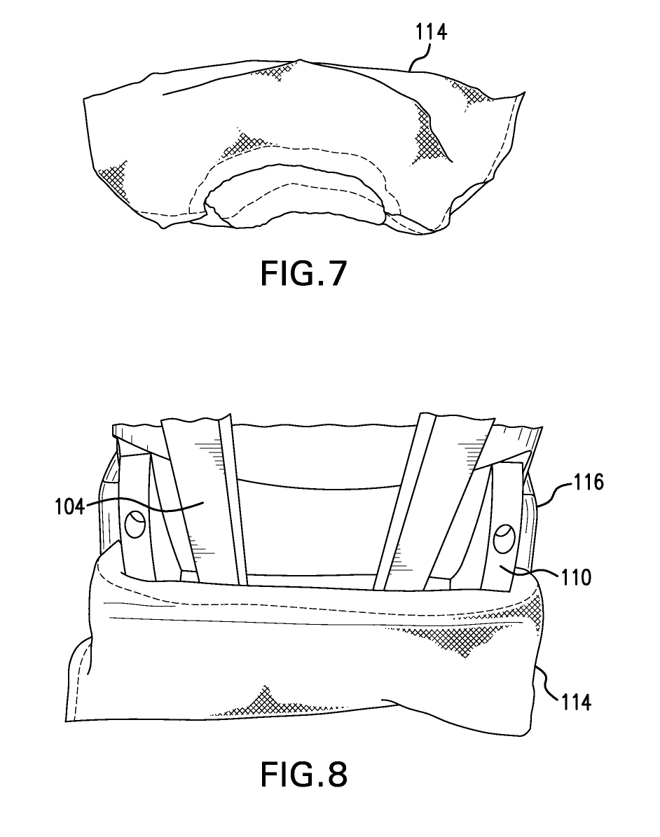

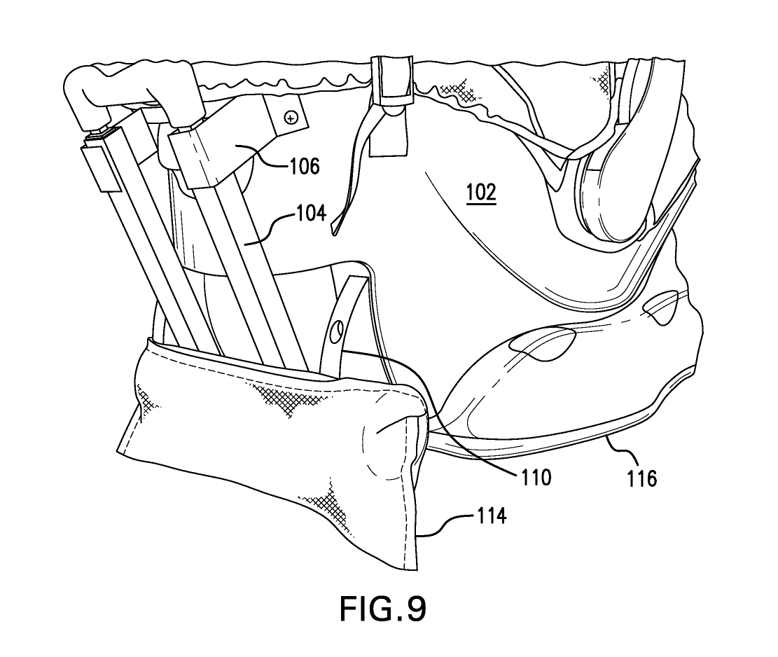

FIG. 7 shows a wheel cover 114 for use with the car seat mobility assembly 100. When using the car seat mobility assembly 100, the wheels 108 may become contaminated with dirt and mud or other material that the user would not want to bring back into their vehicle. The wheel cover 114 is configured to fit over one or both wheels 108. The wheel cover 114 is designed for protection of surfaces and containment of debris upon re-entry into the vehicle after an excursion. In the exemplary embodiment, the wheel cover 114 is a sack with a mouth and an elastic band around the mouth. The wheel cover 114 is made of material that is heavy duty, tear resistant, reuse able, and washable.

Those skilled in the art will recognize that numerous modifications and changes may be made to the exemplary embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the exemplary embodiment is essential. Other embodiments are possible, their specific designs depending upon the particular application. As such, the scope of the invention should not be limited by the particular embodiments herein described but should be defined only by the appended claims and equivalents thereof.

What is claimed is:

1. A device comprising:
a handle;
a handle bracket configured to couple to a car seat;
a first wheel bracket coupled to the handle and configured to couple to the car seat; and
a first wheel coupled to the first wheel bracket.

2. The device of claim 1,
wherein the handle is configured to be adjustable for length.

3. The device of claim 1,
wherein the handle is a telescoping handle.

4. The device of claim 1, further comprising:
wherein the handle is a folding handle.

5. The device of claim 1,
a second wheel bracket coupled to the handle and configured to couple to the car seat;
a second wheel coupled to the second wheel bracket;
an axle rotatingly coupled to the first wheel bracket and second wheel bracket;
wherein the first wheel is coupled to the axle; and
wherein the second wheel is coupled to the axle.

6. The device of claim 1,
wherein the handle is configured to be removeably coupled to the car seat; and
wherein the wheel bracket is configured to be removeably coupled to the car seat.

7. The device of claim 1, further comprising:
a run-away wrist strap coupled to the handle.

8. The device of claim 1, further comprising:
wherein the first wheel bracket is configured to not interfere with a car seat base when the car seat is coupled to the device and the car seat is inserted into the car seat base.

9. The device of claim 1,
wherein the wheel is reflective.

10. The device of claim 1, further comprising:
a wheel cover.
